(19) United States
(12) Patent Application Publication
(10) Pub. No.: US 2011/0135415 A1
(43) Pub. Date: Jun. 9, 2011

(54) VIBRATION SUPPRESSING DEVICE

(75) Inventors: Akihide Hamaguchi, Aichi (JP); Hiroshi Inagaki, Aichi (JP); Kiyoshi Yoshino, Aichi (JP); Tomoharu Ando, Aichi (JP); Hiroshi Ueno, Aichi (JP)

(73) Assignee: OKUMA CORPORATION, Niwa-gun (JP)

(21) Appl. No.: 12/873,856

(22) Filed: Sep. 1, 2010

(30) Foreign Application Priority Data
Sep. 24, 2009 (JP) 2009-219454

(51) Int. Cl. B23Q 15/12

(52) U.S. Cl. 409/79

(57) ABSTRACT

In a vibration suppressing device provided in a machine tool having a rotary shaft for use in rotating a tool or a workpiece, for suppressing chatter vibrations generated during rotation of the rotary shaft, an arithmetical unit performs an analysis on a vibration of the rotary shaft detected by a detector (vibrations sensors) whenever the vibration is detected and a computation based on a result of the analysis. An operator, while checking results of the analysis and/or the computation displayed in real time in a display unit, manipulates a manipulation element to enter a command to change a rotation speed of the rotary shaft into a rotation speed control unit (NC unit) which controls the rotation speed according to the command entered by the operator through the manipulation element.

### BACKGROUND OF THE INVENTION

This application claims the entire benefit of Japanese Patent Application Number 2009-219454 filed on Sep. 24, 2009, the entirety of which is incorporated by reference.

### TECHNICAL FIELD

The present invention relates to a vibration suppressing device, provided in a machine tool configured to perform a machining operation on a workpiece with a tool while rotating the tool or the workpiece, for suppressing chatter vibrations generated during the machining operation.

### BACKGROUND ART

A machine tool in which a tool is supported on a rotary shaft and a machining operation is performed with the spinning tool on a workpiece while the tool and/or the workpiece are being shifted relative to each other is hitherto known in the art. In the machining operation of such a machine tool, the so-called “chatter vibrations” generated for one or more reasons such as an excessively increased amount of cut during a cutting operation would cause problems such as deteriorating the accuracy of a finished surface of the workpiece, and accelerating the wear and loss of the tool. In view of the above, under the status quo, the chatter vibrations may typically be addressed by an operator who changes the rotation speed of the rotary shaft empirically based on the sounds produced in the machining operation so as to suppress the chatter vibrations. In a vibration suppressing device conceivable, as disclosed in JP 2003-340627 A, a natural frequency of the system at which the chatter vibrations occur is given in advance, the frequency of vibrations occurring at the rotary shaft or the like during the machining operation is detected, a stable rotation speed is determined based on the detected frequency of vibrations and the natural frequency, and the rotation speed of the rotary shaft is automatically changed to the determined stable rotation speed.

However, the currently prevailing suppressing method based on the operator's empirical skill has limitations on the suppression effects. Furthermore, it has been shown that the natural frequency varies according to the variation in the supporting force by which the tool is supported on the rotary shaft (for example, in the machine tool having a tool holder held by a chuck, a clamping force by which the tool holder is held by the chuck), the variation in the rigidity of the rotary shaft caused by heat produced therein, or the like. Accordingly, even if the vibration suppressing device as disclosed in JP 2003-340627 A is adopted, the natural frequency given in advance may be different from the actual natural frequency during the machining operation, and thus the chatter vibrations will not be able to be suppressed effectively as the case may be. It is also to be noted that not all of the vibrations occurring at the rotary shaft during the machining operation are the chatter vibrations, and there may also be cases where vibrations other than the chatter vibrations may temporarily develop and increase to a magnitude comparable to the chatter vibrations. It appears, however, that the vibration suppressing device disclosed in JP 2003-340627 A is configured to exercise control such that the rotation speed is changed based on the detected frequency of vibrations that are assumed as chatter vibrations but may possibly not so in actuality. As a result, the control exercised herein over the rotation speed would possibly produce an undesirable effect adverse to the suppression of chatter vibrations as expected.

In addition, with the vibration suppressing device implemented according to the disclosure of JP2003-340627 A, the rotation speed of the rotary shaft is changed automatically only in view of the suppression of chatter vibrations, and the other conditions such as the precision of machining on a surface of a workpiece and the recommended cutting speed of the tool may be subject to change in accordance with this automatic change of the rotation speed. This may result in an undesired finish on the machined surface for the operator, as the case may be.

It would be desirable to provide a vibration suppressing device in which chatter vibrations can be suppressed effectively and swiftly, while improved accuracy of machining on a surface of a workpiece, increased service life of a tool and increased efficiency of machining can be achieved.

The present invention has been made in an attempt to eliminate the above disadvantages, and illustrative, non-limiting embodiments of the present invention overcome the above disadvantages and other disadvantages not described above.

### SUMMARY OF THE INVENTION

To achieve the above objects, the present invention is provided a vibration suppressing device in which the rotation speed of the rotary shaft is not automatically changed but a stable rotation speed as determined is indicated in a display unit so that the operator can manually change the rotation speed.

In accordance with a first aspect of the present invention as embodied and described herein as a first embodiment, a vibration suppressing device provided in a machine tool having a rotary shaft for use in rotating a tool or a workpiece, for suppressing chatter vibrations generated during rotation of the rotary shaft. This vibration suppressing device comprises: a detector configured to detect a vibration of the rotary shaft that is rotating; an arithmetical unit configured to perform an analysis on the vibration detected by the detector whenever the vibration is detected and to perform a computation based on a result of the analysis; a display unit configured to display, in real time, the result of the analysis and/or a result of the computation obtained by the arithmetical unit; a rotation speed control unit configured to control a rotation speed of the rotary shaft; and a manipulation element configured to be manipulated to enter a command to change the rotation speed, into the rotation speed control unit.

In a second aspect of the present invention, the manipulation element may, preferably but not necessarily, be configured to be manipulatable in a manner that permits the rotation speed to be changed continuously.

In a third aspect, the manipulation element may include a pulse signal generator which includes a rotatable pulse handle by manipulation and a scaling adjustment knob through which a scaling factor per one scale marked on the pulse handle is adjustable, whereby an amount of change in the rotation speed is adjustable in accordance with a direction and an amount of rotation of the pulse handle and the scaling factor adjusted through the scaling adjustment knob.

In a forth aspect, the manipulation element may include an overriding switch which includes an adjustment knob rotatable by manipulation, whereby an amount of change in the rotation speed is adjustable in accordance with a direction and an amount of rotation of the overriding switch.

In a fifth aspect, the manipulation element may be embodied in a control panel provided for the rotation speed control unit, which control panel includes a console display and a control part, the console display being configured to indicate an amount of change in the rotation speed and the control part being configured to allow the amount of change in the rotation speed to be determined therethrough.

In a sixth aspect, the manipulation element may be configured to allow a rotation speed changeable range to be set.

In a seventh aspect, the arithmetical unit may be configured to generate a time-base waveform of the vibration detected by the detector, whereby the display unit displays a time-base waveform of the rotation speed and the time-base waveform of the vibration with measurement times of the waveforms being aligned with each other.

In a eighth aspect, the arithmetical unit may be configured to find a vibration for each rotation speed, and generate a graph showing a relationship between the rotation speed and the corresponding vibration, whereby the display unit displays the graph generated by the arithmetical unit.

In a ninth aspect, the arithmetical unit may be configured to find a frequency-domain vibrational acceleration by the analysis, compare a maximum value of the frequency-domain vibrational acceleration with a threshold value to detect occurrence of chatter vibrations, and calculate the stable rotation speed which can suppress the chatter vibration using a chatter frequency at which the frequency-domain vibrational acceleration exhibits the maximum value, whereby the display unit displays the stable rotation speed calculated by the arithmetical unit.

With the configurations described above, various advantageous effects may be expected as follows.

According to one or more aspects of the present invention, as mentioned above particularly in the first aspect, an analysis based on a vibration detected by the detector and a computation based on the result of the analysis are performed by the arithmetical unit whenever detection is made, and the result of the analysis and/or the result of the computation are displayed in the display unit in real time. Accordingly, an operator may manipulate the manipulation element while checking the results of analysis and/or computation displayed in the display unit, to change the rotation speed. Thus, the operator can suppress the chatter vibrations more accurately and more swiftly in comparison with the case with the conventional configuration in which the operator should change the rotation speed based on his/her empirical skills or the like.

Furthermore, the manipulation element is configured to be manipulated to enter a command to change the rotation speed into the rotation speed control unit, as consistent with one or more aspects of the present invention. Thus, the rotation speed of the rotary shaft is changed solely according to the manipulation of the operator, so that the machining operation will be not performed under undesired conditions to the operator. Therefore, the change in the other conditions such as the precision of machining on the surface of a workpiece, the cutting speed of the tool or the like, which had been occurred according to automatical changes of rotation speed in the conventional vibration suppressing device, will not be occurred.

In this configuration, however, the change in the rotation speed which may be effected through the manipulation element by an operator would possibly change the conditions such as the rigidity of the rotary shaft, and eventually cause chatter vibrations at a different frequency to occur with a good probability as the case may be. Therefore, the configuration in which the operator is allowed to manually change the rotation speed to a stable rotation speed indicated in the display unit would possibly impair the time efficiency in that the operator should change the rotation speed again and again until the stable state is finally achieved.

With this in view, according to the configuration described in the second aspect above, the manipulation element may be configured to be manipulatable in a manner that permits the rotation speed to be changed continuously. With this feature, the undesirable events, such as breakage of a tool, which would otherwise take place upon abrupt change in the rotation speed can be prevented, and the change to the rotation speed at which chatter vibrations will be most effectively suppressed can be effected accurately and swiftly. Moreover, as compared with the configuration in which the operator may have to manually change the rotation speed by entering the would-be stable rotation speed indicated in the display unit again and again until the stable state is actually achieved, the time required to find the stable rotation speed at which chatter vibrations will be most effectively suppressed can be reduced. Consequently, even in the event of strong chatter vibrations, the rotation speed can be swiftly changed so that breakage of a tool or the like can be prevented.

With the configurations described above in the third to fifth aspects, in which the manipulation element includes a pulse signal generator, an overriding switch or a control panel, the command to change the rotation speed can be entered easily and conveniently. In particular, with the configuration described in the fifth aspect, in which the manipulation element is embodied in the control panel provided for the rotation speed control unit, the necessity to provide a dedicated manipulation element is obviated and thus the cost can be reduced.

With the configuration described above in the sixth aspect, in which the rotation speed changeable range can be set in the manipulation element, the operator so absorbed by suppressing chatter vibrations will be stopped from changing the rotation speed excessively to a speed which should entail undesirable changes in the other machining conditions. Therefore, the workability of the machine tool can be improved.

With the configuration described above in the seventh aspect, in which a time-base waveform of the vibration detected by the detector is generated in the arithmetical unit, and a time-base waveform of the rotation speed and the time-base waveform of the vibration are displayed in the display unit with measurement times of the waveforms being aligned with each other, the operator can easily grasp the status of occurrence of chatter vibrations.

With the configuration described above in the eighth aspect, in which a vibration for each rotation speed is found in the arithmetical unit to generate a graph showing a relationship between the rotation speed and the corresponding vibration for display in the display unit, the operator can easily grasp a vibration corresponding to each rotation speed.

With the configuration described above in the ninth aspect, as a stable rotation speed which can suppress the chatter vibration is calculated for display in the display unit, the operator can more effectively and more swiftly suppress the chatter vibrations.

### BRIEF DESCRIPTION OF DRAWINGS

The above aspect, other advantages and further features of the present invention will become more apparent by describing in detail illustrative, non-limiting embodiments thereof with reference to the accompanying drawings, in which:

FIG. 1 is a block diagram of a vibration suppressing device;

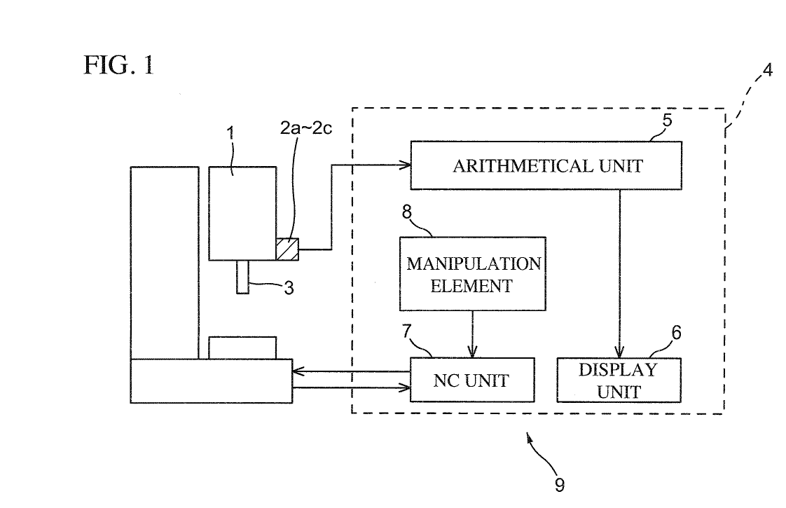

FIG. 2 is a schematic diagram of a rotary shaft housing as viewed from sideward;

FIG. 3 is a schematic diagram of the rotary shaft housing as viewed in an axial direction thereof;

FIG. 4 is a schematic diagram showing a pulse signal generator as one example of a manipulation element;

FIG. 5 is a flowchart showing a control flow for suppressing chatter vibrations;

FIG. 6 a schematic diagram showing a rotation speed changeable range;

FIG. 7 is a schematic diagram showing an illustrative display representation in which a time-base waveform of a rotation speed and a time-base waveform of a vibrational acceleration are displayed with measurement times of the waveforms being aligned with each other;

FIG. 8 is a schematic diagram showing an illustrative display representation in which the vibrational acceleration for each rotation speed is displayed where the horizontal axis indicates the rotation speed and the vertical axis indicates the vibrational acceleration;

FIG. 9 is a schematic diagram showing an override switch as a modified example of the manipulation element; and

FIG. 10 is a schematic diagram showing a control panel as another modified example of the manipulation element.

### DESCRIPTION OF EMBODIMENTS

A vibration suppressing device according to one embodiment of the present invention will be described in detail with reference to the drawings.

A vibration suppressing device 9 is a device for suppressing chatter vibrations occurring at a rotary shaft 3 provided in a rotary shaft housing 1 in such a manner that the rotary shaft 3 is rotatable about a C-axis. The vibration suppressing device 9 includes vibration sensors 2a-2c configured to detect vibrational accelerations of the rotary shaft 3 that is rotating, and a controller 4 configured to control over the rotation speed of the rotary shaft 3 to be exercised based on the detection values output from the vibrations sensors 2a-2c.

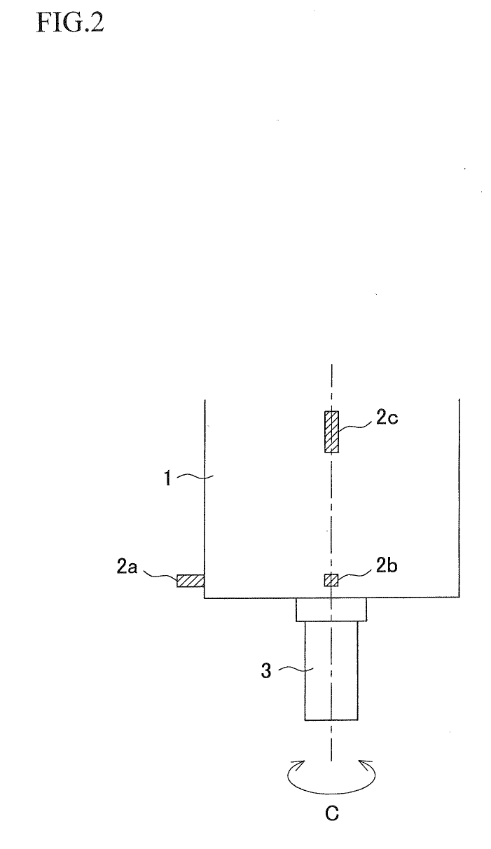

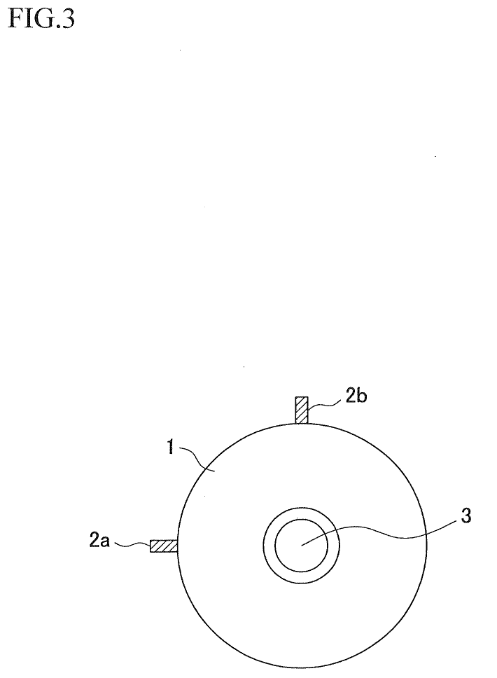

The vibration sensors 2a-2c are mounted at the rotary shaft housing 1 as shown in FIGS. 2 and 3, and configured such that one vibration sensor detects a vibrational acceleration in a direction perpendicular to directions of vibrational accelerations which the other two vibration sensors detect. Accordingly, the directions of the vibrational accelerations detected by the vibration sensors 2a-2c are along X-axis, Y-axis and Z-axis directions, respectively which are orthogonal to each other.

The controller 4 includes an arithmetical unit 5, a display unit 6, a numerical control or NC unit 7, a manipulation element 8, and a storage device (not shown). The arithmetical unit 5 is configured to perform an analysis based on the vibrational accelerations detected by the vibration sensors 2a-2c and to perform various operations (computation) which will be described later, based on the result of the analysis. The display unit 6 is configured to display the result of the analysis and/or the result of the computation obtained by the arithmetical unit. The NC unit 7 is configured to control a rotational motion of the rotary shaft 3 and other operations. The manipulation element 8 is configured to be manipulated to enter a command to change the rotation speed into the NC unit 7. The controller 4 always monitors the rotation speed of the rotary shaft 3, and allow the analysis and/or the computation in the arithmetical unit 5 as will be described later to be performed in real time.

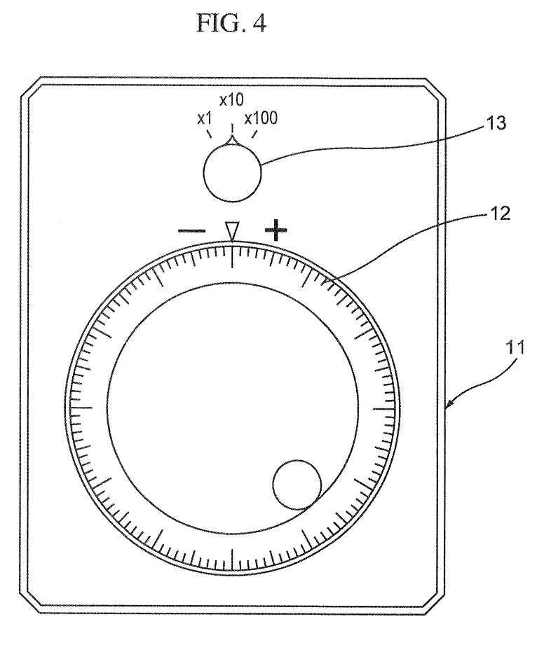

The manipulation element 8 in this embodiment is embodied as a pulse generator 11 as shown in FIG. 4, and includes a pulse handle 12 which can be turned manually by an operator, and a scaling adjustment knob 13 through which a scaling factor per one scale marked on the pulse handle 12 is adjustable. The pulse handle 12 is configured to allow continuous change of the rotation speed of the rotary shaft 3 to be made in 1 min⁻¹ steps at the minimum by the operator's manual turning operation. The scaling adjustment knob 13 renders the amount of change in the rotation speed per one step of the turning operation configurable to be any one of three scaling factors of 1, 10 and 100. Accordingly, when the pulse handle 12 is turned one step (scale) with the scaling factor being set at 1, the rotation speed of the rotary shaft 3 is changed by 1 min⁻¹ (i.e., a command to change the rotation speed as such is sent to the NC unit 7). On the other hand, when the pulse handle 12 is turned one step (scale) with the scaling factor being set at 100, the rotation speed of the rotary shaft 3 is changed by 100 min⁻¹. When the pulse handle 12 is turned clockwise, the rotation speed increases, and when the pulse handle 12 is turned counterclockwise, the rotation speed decreases.

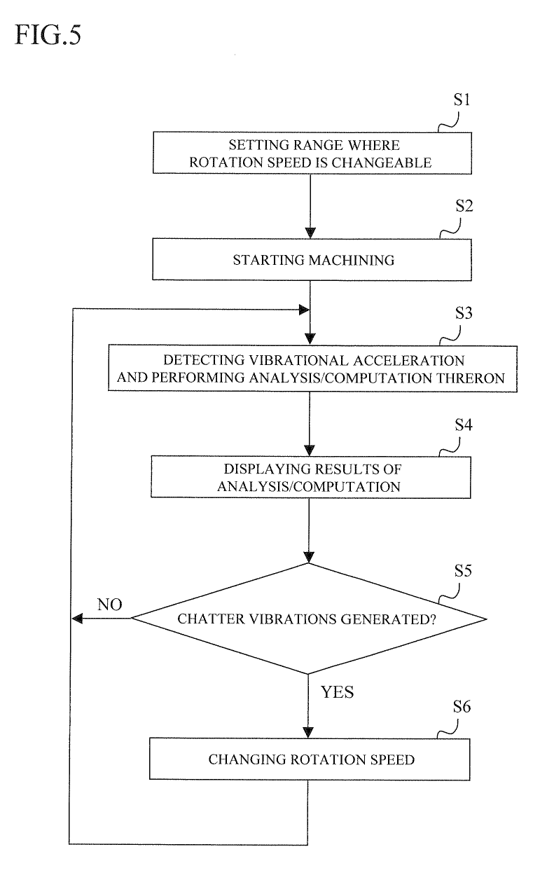

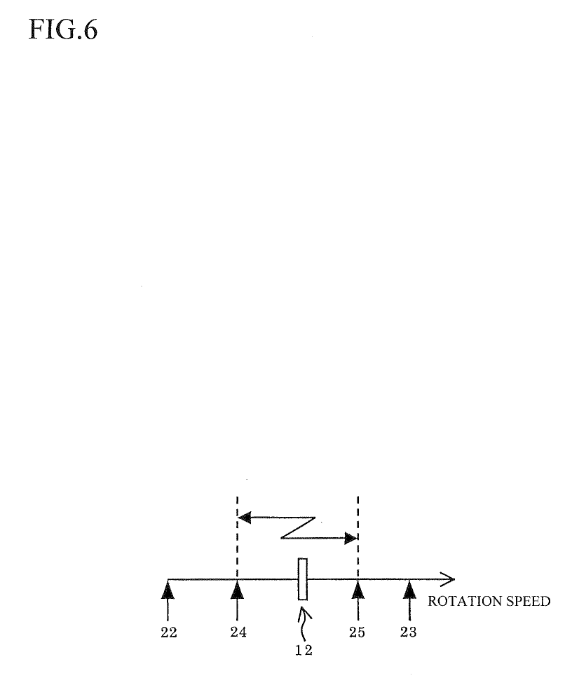

Now, a control exercised by the controller 4 to suppress scatter vibrations will be described based on the flowchart in FIG. 5, and with reference to FIGS. 6-8.

First, a lower-limit rotation speed 22 (shown in FIG. 6; hereinafter, for reference numerals affixed to any specific rotation speed, see FIG. 6) and an upper-limit rotation speed 23 of the rotation speed of the rotary shaft 3 as determined based on the conditions concerning the shape of a workpiece, the tool used, etc. are stored in the storage device (S1). Further, an operator's set lower-limit rotation speed 24 and an operator's set upper-limit rotation speed 25 as determined by an operator based on the necessary conditions concerning the precision of machining on the surface of a workpiece, etc. are stored in the storage device (S1). According to the settings stored as described above, the change in the rotation speed of the rotary shaft 3 after the beginning of machining is permitted only in the range between the higher of the two lower-limit rotation speeds 22 and 24 (in this embodiment, the operator's set lower-limit rotation speed 24) and the lower of the two upper-limit rotation speeds 23 and 25 (in this embodiment, the operator's set upper-limit rotation speed 25), as shown in FIG. 6.

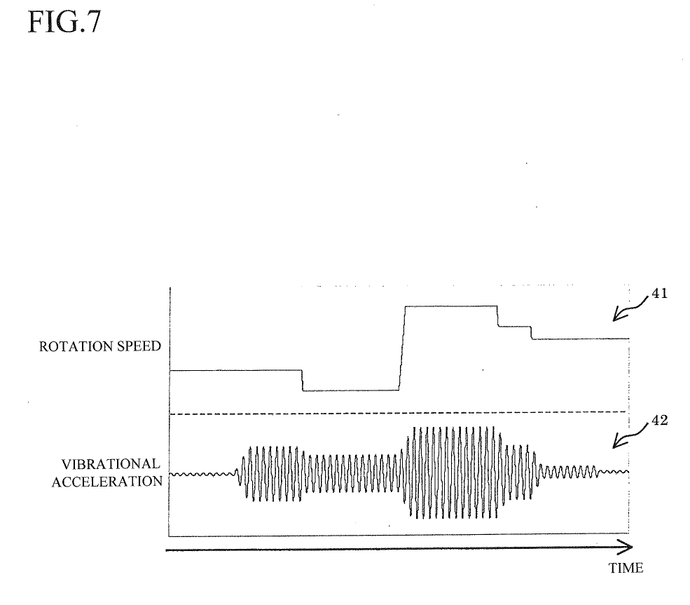

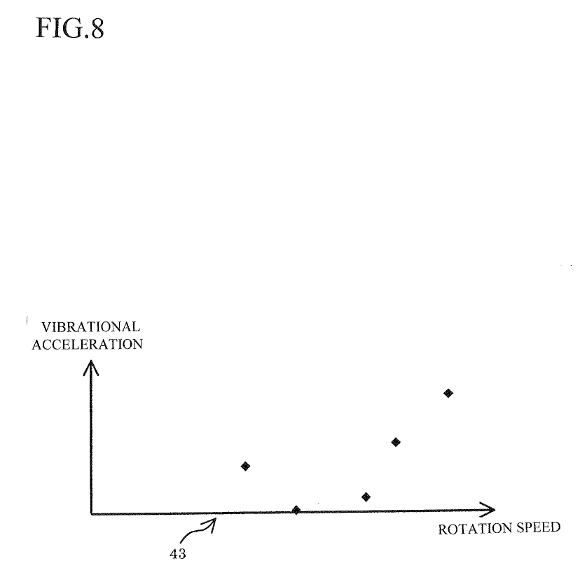

Thereafter, when the machining is started with an initial rotation speed selected within the range of the rotation speeds in which change is permitted (S2), the controller 4 continuously receives the vibrational accelerations detected by the vibration sensors 2a-2c, and causes the arithmetical unit 5 to perform an analysis on the received vibrational accelerations and a computation based on the result of the analysis (S3). The controller 4 then causes the display unit 6 to display, in real time, the result of the analysis and/or the result of the computation obtained by the arithmetical unit 5 (S4). Display representation in the display unit 6 may be, for example, in the form of a time-base waveform of the vibrational acceleration generated by the arithmetical unit 5 or in the form of a waveform obtained through a frequency analysis performed by the arithmetical unit 5 on the vibrational acceleration whenever vibration is detected. Alternatively, a time-base waveform 41 of the rotation speed of the rotary shaft 3 and a time-base waveform 42 of the vibrational acceleration may be stored and displayed in the display unit 6 with measurement times of the waveforms being aligned with each other, as shown in the graph of FIG. 7. Further alternatively, a vibrational acceleration 43 for each rotation speed may be obtained based on the result shown in FIG. 7 and displayed in the graph as shown in FIG. 8, representing a relationship between the rotation speed and the corresponding vibrational acceleration where the horizontal axis indicates the rotation speed and the vertical axis indicates the vibrational acceleration. In this instance, the vibrational acceleration shown in the vertical axis may be taken from peak values of the time-base waveform or peak values of the waveform obtained by the frequency analysis.

Through the display representation as described above in the display unit 6, the operator can check the status of occurrence of the chatter vibrations and the magnitude of the vibrational acceleration for each rotation speed of the rotary shaft 3 (S5).

When the operator has recognized the occurrence of the chatter vibrations, the operator manipulates the manipulation element 8 to continuously change the rotation speed of the rotary shaft 3 (S6). The change in the rotation speed effected through manipulation of the manipulation element 8 by the operator entails a change in the vibrational acceleration which is being detected by the vibration sensors 2a-2c, and as the analysis on the vibrational acceleration is performed timely in the arithmetical unit 5, this change in the vibrational acceleration is displayed in real time in the display unit 6. Therefore, the operator may manipulate the manipulation element 8 to change the rotation speed while checking the state of change in the vibrational acceleration in the display unit 6, so as to reduce the chatter vibrations. In the operation of changing the rotation speed in step S6, the rotation speed can be changed only within the permitted range as stored in step S1.

With the vibration suppressing device 9 configured as described above, the analysis based on the vibration accelerations detected by the vibration sensors 2a-2c and the computation based on the result of the analysis are performed timely in the arithmetical unit 5, and the results of the analysis and the computation are displayed in the display unit 6 in real time. Accordingly, the operator who intends to suppress the chatter vibrations may manipulate the manipulation element 8 to change the rotation speed, while checking the results displayed in the display unit 6. Thus, the chatter vibrations can be suppressed more accurately and more swiftly as compared with the conventional system with which the operator changes the rotation speed based on his/her empirical skills.

Moreover, since the manipulation element 8 with which the NC unit 7 is operated is provided in the vibration suppressing device 9, the rotation speed of the rotary shaft 3 can be changed solely through the operator's manual operation. Thus, machining under conditions such as not to be wished by the operator will never be carried out. Accordingly, it is unlikely that the change in the rotation speed effected automatically will entail the change in the other conditions such as the precision of machining on the surface of a workpiece and the cutting speed of the tool, as may be the case with the conventional vibration suppressing device.

Furthermore, since the range where a rotation speed is changeable is set, the operator so absorbed by suppressing chatter vibrations will be stopped from changing the rotation speed excessively to a speed which should entail undesirable changes in the other machining conditions. Therefore, the workability of the machine tool is improved.

Furthermore, since the time-base waveform 41 of the rotation speed of the rotary shaft 3 and the time-base waveform 42 of the vibrational acceleration which are obtained in the arithmetical unit 5 are displayed in the display unit 6 with measurement times of the waveforms 41, 41 being aligned with each other, as shown in the graph of FIG. 7, or the rotation speed and the corresponding vibration acceleration as obtained in the arithmetical unit 5 are displayed in the display unit 6 in a correlated manner as shown in the graph of FIG. 8, the operator can easily grasp the status of the occurrence of chatter vibrations or the vibrational acceleration corresponding to each rotation speed.

In addition, since the manipulation element 8 is embodied as a pulse signal generator 11 which includes a pulse handle 12 and a scaling adjustment knob 13 through which a scaling factor per one scale marked on the pulse handle 12 is adjustable, the operator can conveniently change the rotation speed only by manipulating the pulse handle 12 and the scaling adjustment knob 13. Further, the rotation speed of the rotary shaft 3 can be changed continuously by 1 min⁻¹ at the minimum through the manual operation of the pulse signal generator 11, fine adjustments of the rotation speed can be made, without the possibility of effecting the change in the rotation speed excessively beyond the rotation speed at which chatter vibrations can be suppressed, so that change to a rotation speed at which the chatter vibrations can be suppressed most effectively can be made more accurately and more swiftly.

According to a vibration suppressing device where an optimum speed is specified, an abrupt change in the rotation speed may produce an excessive load applied to a tool or the machine, resulting in breakage thereof. In contrast, the vibration suppressing device 9 in this embodiment as described above, there is no potential for breakage of a tool or the like due to an abrupt change in the rotation speed because the rotation speed can be continuously changed through the manual operation of the pulse signal generator 11. Furthermore, the use of the manipulation element 8 enables the change in the rotation speed to be made simply by manually operating the pulse handle 12, and thus the time required to change the rotation speed can be reduced in comparison with a device with which a rotation speed may be entered every time when the rotation speed is to be changed. Consequently, even when large chatter vibrations occur, the rotation speed can be changed swiftly and the breakage of a tool or the like can be prevented.

Components and their arrangement of the vibration suppressing device as consistent with the present invention are not limited to those of the above-described embodiment, and various changes and modifications may be made to the configurations concerning the detection, analysis and computation of the vibrational acceleration, and the control for suppressing vibrations, where appropriate on an as needed basis without departing from the scope of the appended claims.

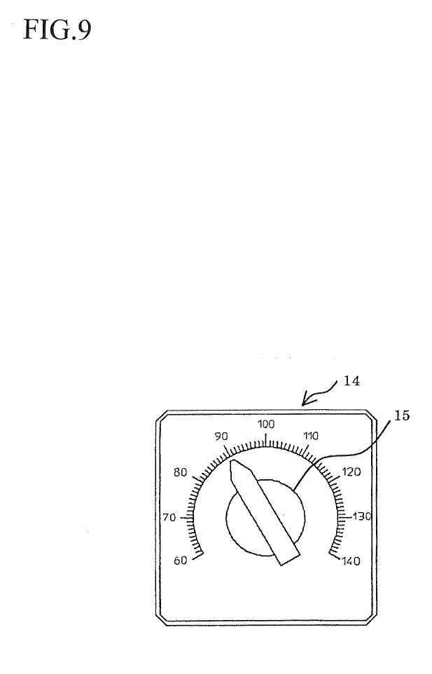

For example, as the manipulation element 8, an override switch 14 as shown in FIG. 9 may be adopted. The override switch 14 includes an adjustment knob 15 that is rotatable by manipulation, and a detector configured to detect the angular displacements of the adjustment knob 15. When the adjustment knob 15 is rotated by an angle corresponding to one scale, the rotation speed can be changed by 1% (i.e., in order to change the current rotation speed to a rotation speed resulting from multiplication of the current rotation speed by 0.99 or 1.01 can be issued to the NC unit 7). In this embodiment, when the adjustment knob 15 is turned clockwise, the rotation speed increases, and when the adjustment knob 15 is turned counterclockwise, the rotation speed decreases.

When the override switch 14 as described above is adopted as the manipulation element 8, the operator can continuously change the rotation speed only through the manual operation of the adjustment knob 15, and thus the device is very convenient, as in the case with the pulse signal generator 11. In contrast to the prevailing override switch with which the rotation speed is changed by 10%, the override switch 14 shown in FIG. 9 is configured to be able to continuously change the rotation speed by 1%, and thus fine adjustments of the rotation speed can be made. Therefore, it is unlikely that the rotation speed will be changed beyond a rotation speed at which chatter vibrations can be suppressed, and the rotation speed can be changed accurately and swiftly to a rotation speed at which chatter vibrations can be suppressed most effectively.

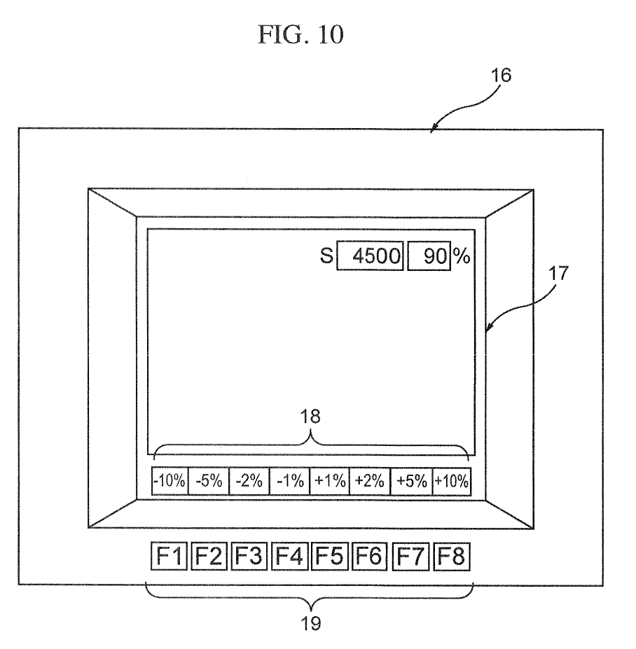

Alternatively, a control panel 16 as shown in FIG. 10 may be adopted as the manipulation element 8. This control panel 16 includes a console display 17, a change percentage display portion 18 displayed in the console display 17, and function keys (control portion) 19 arranged in positions corresponding to the positions of respective percentages represented in the change percentage display portion 18. The control panel 16 is provided in the NC unit 7. The rotation speed can be changed with ±1%, ±2%, ±5%, or ±10% by manual operation of any one of the function keys 19 corresponding to the indications displayed on the change percentage display portion 18.

When the control panel 16 as described above is adopted as the manipulation element 8, the operator can continuously change the rotation speed conveniently through the simple manual operation of the function keys 19, and fine adjustments can be made to the rotation speed, so that the chatter vibrations can be suppressed effectively. Furthermore, since the control panel 16 provided for the NC unit 7 is also used for the manipulation element 8, there is no need to provide a dedicated manipulation element for changing the rotation speed, and thus the cost can be reduced. Instead of the function keys 19 provided adjacent the change percentage display portion 18, the change percentage display portion 18 may be configured to serve as a touch-screen operation switch so that the rotation speed can be changed by touching any one of the indications of percentages displayed in the change percentage display portion 18 of the console display 17.

In the above-described embodiment, the operator is allowed to determine whether chatter vibrations are generated, reduced, or otherwise observed, based on the display representation in the display unit 6. However, the controller 4 may be configured such that the arithmetical unit 5, in lieu of the operator, determines whether chatter vibrations are generated, reduced, or otherwise observed, based on the results of detection of the vibrational accelerations so that the generation or suppression of chatter vibrations are displayed in the display unit 6, or various results of analysis and/or computation of the arithmetical unit 5 are displayed to prompt the operator to change the rotation speed only when the chatter vibrations are observed. Determination as to whether chatter vibrations are generated may be made under control such that the vibrational accelerations detected by the vibration sensors 2a-2c are subjected to frequency analysis, and the maximum value of the frequency-domain vibrational acceleration obtained through the frequency analysis is compared with a predetermined threshold value, to determine that the chatter vibrations are generated if the maximum value is greater than the threshold value, while the chatter vibrations are suppressed if the maximum value is smaller than the threshold value.

The controller 4 in which the arithmetic unit 5 determines whether chatter vibrations are generated as described above may be configured to calculate, after detection of chatter vibrations, a stable rotation speed at which the chatter vibrations can be suppressed, based on a “chatter frequency” at which the frequency-domain vibrational acceleration exhibits the maximum value (the “chatter frequency” can be obtained through the frequency analysis on the vibrational accelerations detected by the vibration sensors 2a-2c) or the number of tool flutes, and to display the calculated stable rotation speed in the display unit 6. With this configuration, the chatter vibrations can be suppressed more effectively and more swiftly. In practice, it is likely that the calculated stable rotation speed is not the most effective rotation speed because of various factors such as the change in environment due to various detection errors and the change in the rotation speed. For this reason, if the stable rotation speed is automatically calculated after the rotation speed is changed to the would-be stable rotation speed, and a renewed stable rotation speed is displayed again. In this way, the operator is obliged to change the rotation speed again and again, and thus required time and manpower would probably become a nonnegligible problem. However, in this embodiment, the status of the chatter vibrations is displayed in real time in the display unit 6, and thus a rotation speed at which the chatter vibrations can be suppressed most effectively can be found from around the stable rotation speed during the operation of changing the rotation speed to the stable rotation speed, so that the chatter vibration-suppressing effects can be improved easily and swiftly.

Calculation of the stable rotation speed can be performed by a method disclosed in the applicant's own prior application as laid open under JP 2008-290188 A (a corresponding U.S. patent application is published under US 2008/0289923 A1), or by using the following equation (1):

$$Stable\_Rotation \_Speed = \frac{60 \times Chatter\_Frequency}{Number\_of \_Tool \_Flutes \times ( k\_value + 1 )} \qquad ( 1 )$$

where the number of tool flutes is the number of flutes of the tool installed to the rotary shaft 3, and inputted and set in the arithmetic unit 5 beforehand, and k value is an integer.

In the above-described embodiment, the detector is embodied as the vibration sensors 2a-2c, but any other detector may be adopted such as those which can detect the displacement of the rotary shaft or the sound pressure due to vibrations. In cases where the vibration sensors are utilized, the sensors may be configured not to detect vibrations of a rotating body (i.e., the rotary shaft) as in the-above described embodiment, but to detect vibrations of a stationary body, instead.

Furthermore, in the above-described embodiment, the rotation speeds and the vibrational accelerations are displayed in a correlated manner as shown in FIGS. 7 and 8, but other parameters such as vibration frequency, cutting speed, feed speed, and rotary shaft torque may be displayed additionally or alternatively.

Furthermore, in the above-described embodiment, the rotation speed changeable range is set with the lower-limit and upper-limit rotation speeds and the operator's set lower-limit and upper-limit rotation speeds as inputted, but may alternatively be set to be the initial rotation speed (the rotation speed upon startup of machining)±a predetermined amount (e.g., 500 min⁻¹). Rather, if not required, the rotation speed changeable range may not be set.

Furthermore, the amount of change in the rotation speed in the manipulation element 8 may be configured differently where appropriate. For example, in the above-described embodiment, the pulse signal generator 11 is configured to have the rotation speed changeable by 1 min⁻¹, but the pulse signal generator 11 may, similar to the override switch 14, have the rotation speed changeable by 1%. It is to be understood that the change in the rotation speed may be made by finer steps or by rougher steps as long as the object of the present invention can be achieved. Also, in cases where the override switch 14 or the control panel 16 is adopted as the manipulation element, the change in the rotation speed may be made by ±0.5%, for example. Moreover, in cases where the override switch 14 or the control panel 16 are adopted as the manipulation element, as well, the rotation speed may be configured to be changeable for example by 1 min⁻¹ as is the case with the pulse signal generator 11.

In addition, the machine tool consistent with the present invention is not limited to a machining center which is configured to rotate a tool for machining, but the present invention may be applied to a lathe or other machine tools which is configured to rotate a workpiece. Furthermore, the positions in which the detectors are installed, and the number of detectors may be changed where appropriate in accordance with the type and size of the machine tool.

1. A vibration suppressing device provided in a machine tool having a rotary shaft for use in rotating a tool or a workpiece, for suppressing chatter vibrations generated during rotation of the rotary shaft, the vibration suppressing device comprising:
a detector configured to detect a vibration of the rotary shaft that is rotating;
an arithmetical unit configured to perform an analysis on the vibration detected by the detector whenever the vibration is detected and to perform a computation based on a result of the analysis;
a display unit configured to display, in real time, at least the result of the analysis or a result of the computation obtained by the arithmetical unit;
a rotation speed control unit configured to control a rotation speed of the rotary shaft; and
a manipulation element configured to be manipulated to enter a command to change the rotation speed, into the rotation speed control unit.

2. The vibration suppressing device according to claim 1, wherein the manipulation element is configured to be manipulatable in a manner that permits the rotation speed to be changed continuously.

3. The vibration suppressing device according to claim 1, wherein the manipulation element includes a pulse signal generator which includes a rotatable pulse handle by manipulation and a scaling adjustment knob for adjusting a scaling factor per one scale marked on the pulse handle, whereby an amount of change in the rotation speed is adjustable in accordance with a direction and an amount of rotation of the pulse handle and the scaling factor adjusted through the scaling adjustment knob.

4. The vibration suppressing device according to claim 1, wherein the manipulation element includes an overriding switch with an adjustment knob rotatable by manipulation, whereby an amount of change in the rotation speed is adjustable in accordance with a direction and an amount of rotation of the overriding switch.

5. The vibration suppressing device according to claim 1, wherein the manipulation element is embodied in a control panel provided for the rotation speed control unit, the control panel including a console display and a control part, the console display being configured to indicate an amount of change in the rotation speed and the control part being configured to allow the amount of change in the rotation speed to be determined therethrough.

6. The vibration suppressing device according to claim 1, wherein the manipulation element is configured to set a range where a rotation speed is changeable.

7. The vibration suppressing device according to claim 1, wherein the arithmetical unit is configured to generate a time-base waveform of the vibration detected by the detector, whereby the display unit displays a time-base waveform of the rotation speed and the time-base waveform of the vibration with measurement times of the waveforms being aligned with each other.

8. The vibration suppressing device according to claim 1, wherein the arithmetical unit is configured to find a vibration for each rotation speed, and generate a graph showing a relationship between the rotation speed and the corresponding vibration, whereby the display unit displays the graph generated by the arithmetical unit.

9. The vibration suppressing device according to claim 1, wherein the arithmetical unit is configured to find a frequency-domain vibrational acceleration by the analysis, compare a maximum value of the frequency-domain vibrational acceleration with a threshold value to detect occurrence of chatter vibrations, and calculate a stable rotation speed which can suppress the chatter vibration using a chatter frequency at which the frequency-domain vibrational acceleration exhibits the maximum value, whereby the display unit displays the stable rotation speed calculated by the arithmetical unit.
